(19) United States
(12) Patent Application Publication
(10) Pub. No.: US 2008/0193635 A1
(43) Pub. Date: Aug. 14, 2008

(54) Anti-Reflecting Coatings for Solar Batteries and Method for the Production Thereof

(76) Inventors: Vladimir Aroutiounian, Yerevan (AM); Khachatur Martirosyan Avan-Arindj, Yerevan (AM); Patrick Soukiassian, Saint Remy Les Chevreuse (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/628,471

(22) PCT Filed: Jun. 1, 2005
(86) PCT No.: PCT/FR2005/001341

§ 371 Date: Nov. 7, 2007

(30) Foreign Application Priority Data
Jun. 2, 2004 (FR) 0405933

(51) Int. Cl. B05D 5/12; G02B 5/20

(52) U.S. Cl. 427/74; 252/584

(57) ABSTRACT

The invention relates to an anti-reflecting coating (20) comprising a combined inner coating (21), made of anti-reflecting silicon, and outer coating (22) made of carbon in the form of an amorphous diamond which is essentially non-porous and essentially devoid of foreign species. The invention also relates to a method for the production of an anti-reflecting coating and to the use thereof as a coating for a solar batter (10). The coating is less likely to deteriorate with time and can improve the spectral domain of efficient conversion of radiation.

The present invention generally relates to anti-reflective coatings, methods for the production thereof and the use thereof, in particular as coatings for solar cells.

Today, reducing the reflection factor of surfaces is one of the best ways to improve the performance of solar cells, and anti-reflective coatings have already been developed to this end. In particular, a porous-silicon coating has been used as an anti-reflective coating to improve the conversion factor of solar cells by decreasing the quantity of sunlight reflected by the face of the cell.

However, such a porous Si coating has disadvantages, in particular the property of being likely to degrade over time, thus decreasing its anti-reflective capacity.

The present invention seeks to overcome these disadvantages and to propose an anti-reflective coating for solar cells which is less likely to degrade over time, without harming the performance of the solar cell.

Another objective of the present invention is to make it possible to adjust and to optimize the spectral range in which the effective conversion of light into electric power can be achieved within the solar cell. More precisely, an objective is to enlarge the spectral range in the direction of the ultraviolet (UV) region.

According to a first aspect, the present invention proposes an anti-reflective coating, in particular for solar cells, wherein it is comprised of, in combination, an internal coating of anti-reflective porous silicon and an external coating of amorphous diamond-like carbon which is essentially non-porous and essentially devoid of foreign species.

In the combination of the internal coating of anti-reflective porous silicon and the external coating of amorphous diamond-like carbon, the cores at the interface of these two coatings coalesce in such a way that a porous-silicon surface geometry is not reproduced.

Certain preferred, but non-limiting, aspects of this coating are as follows:
the volume of the porosity of the coating of amorphous diamond-like carbon is less than 50% of the total volume of the aforesaid coating,
the coating of porous silicon has a thickness between approximately 38 nm and 56 nm,
the coating of porous silicon has a refractive index between approximately 2.6 and 2.9,
the coating of amorphous diamond-like carbon has a thickness between approximately 72 nm and 104 nm, and
the coating of amorphous diamond-like carbon has a refractive index between approximately 1.6 and 1.8.

In a specific embodiment, the coating of porous silicon has a thickness of approximately 42 nm and a refractive index of approximately 2.9, whereas the coating of amorphous diamond-like carbon has a thickness of approximately 88 nm and a refractive index of approximately 1.6.

Thanks to the present invention, a reflection factor for the anti-reflective coating can be obtained that is less than 5.5% in the 400-900 nm range when the aforesaid coating is produced using all of the thickness and refractive index values indicated above for the coating of porous silicon and the coating of amorphous diamond-like carbon.

According to a second aspect, the present invention proposes a method that makes it possible to form an anti-reflective coating on an item having an exposed surface of solid silicon, such as a solar panel, wherein it is comprised of the following steps:
application of a porosification treatment to the exposed surface of solid silicon at a predetermined thickness in such a way as to form a coating of porous silicon, and
deposition of a solid coating of amorphous diamond-like carbon, one which is essentially free of foreign species, on the aforesaid coating of porous silicon.

Certain preferred, but non-limiting, aspects of the method are as follows:
the porosification treatment is anodization;
the anodization etching agent is selected among a mixture of hydrofluoric acid and dimethylformamide and a mixture of hydrofluoric acid and ethanol;
the step of deposition of the solid coating of amorphous diamond-like carbon is carried out by ion sputtering using a graphite target;
the graphite target is bombarded with argon ions;
the step of deposition of the solid coating of amorphous diamond-like carbon is carried out by electron bombardment of toluene vapor.

Lastly, the present invention proposes the use of an anti-reflective coating such as defined above as a coating for a solar cell.

Other aspects, aims and advantages of the present invention will more readily come to light upon the reading of the following detailed description of one of the embodiments thereof, which is given only as example and which is presented in reference to the appended drawings, in which:

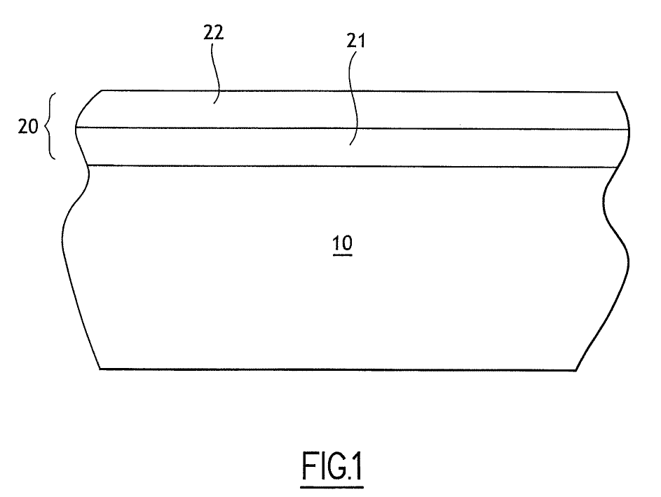

FIG. 1 is a schematic diagram of a solar panel equipped with an anti-reflective coating according to the present invention,

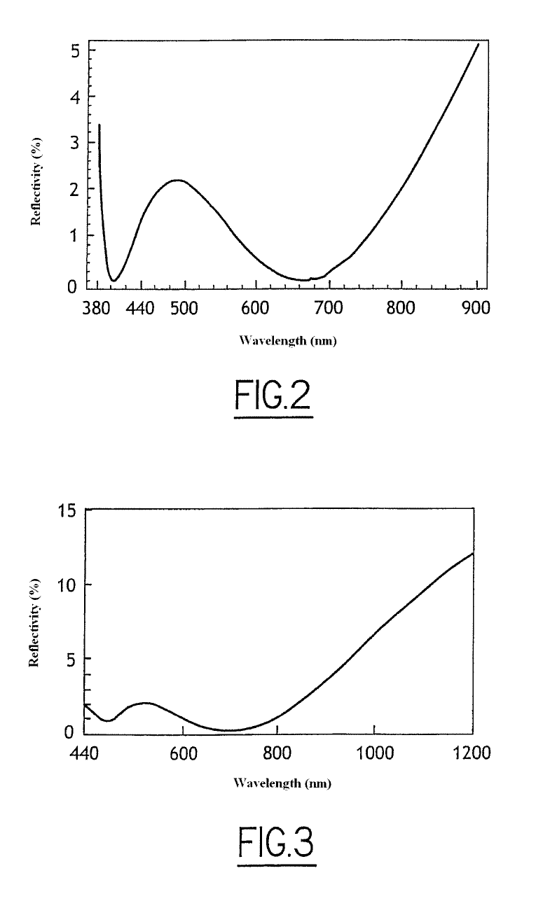

FIG. 2 is the reflection factor/wavelength curve for a first example of a coating according to the present invention, and

FIG. 3 is the reflection factor/wavelength curve for a second example of a coating according to the present invention.

In FIG. 1, the schematic diagram consists of a flat solar panel 10, equipped with an anti-reflective coating 20 according to the present invention.

Coating 20 contains an internal coating 21 of porous silicon and an external coating 22 of hard amorphous carbon, also called amorphous diamond-like carbon.

The porosity of the silicon is determined by the deposition method used.

Hard amorphous carbon is known in the art as being a carbon that is generally deposited in the form of a film containing a significant fraction of sp3-hybridized carbon atoms. These amorphous diamond-like carbon (DLC) films or coatings can contain a significant fraction of hydrogen.

Generally, the various types of DLC are differentiated with respect to hydrogen according to the deposition method.

Moreover, in the current state of the art, hydrogen-free DLC films can, in particular, be prepared by ion sputtering of graphite or toluene, these techniques also making it possible to avoid or minimize the presence of additional foreign species such as nitrogen.

For further details on these subjects, refer to the IUPAC (International Union of Pure and Applied Chemistry) standard, in particular.

The porous silicon is preferably formed on the solar panel by an electrochemical anodization process. In the present example, an electrochemical etching or anodization process is carried out on the surface of the panel as described above, after degreasing said panel and washing said panel with pure water.

An electrolyte comprised of 4 M dimethylformamide in hydrofluoric acid (HF) in a 1:1 molar ratio with water is used to obtain macroporous silicon (pore size between 200 nm and 2 m).

As an alternative, an electrolyte comprised of equal quantities of 48% HF and 96% ethanol (C₂H₅OH) can be used to obtain microporous silicon (pore size between 10 nm and 100 nm).

Several samples were prepared with various current densities and etching times. More particularly, current densities between 1 mA/cm² and 15 mA/cm² for time periods between 5 seconds and 10 minutes were used and the anodization process was carried out under constant illumination from a 1 kW halogen lamp placed at a distance of 20 cm from the surface to be anodized.

The coating of porous silicon has a thickness (designated d_{PS}) of approximately 20 nm or more, preferably between approximately 38 nm and 56 nm. In addition, the conditions of anodization are selected in such a way that the refractive index (n_{PS}) of coating 21 is between approximately 2.6 and 2.9.

After having formed porous silicon coating 21 by the anodization process above, the coating of amorphous diamond-like carbon 22 is formed directly over coating 21.

Two techniques can be used to this end.

A first technique is ion sputtering using a graphite target. More particularly, a graphite target is irradiated with argon ions in such a way as to deposit a coating of amorphous diamond-like carbon 22, according to a known technique.

Various irradiation densities are used.

The films are obtained in the direct current ion plasma deposition chamber equipped with a source of direct current ions. The working current is between 0.1 mA and 20 mA under an accelerating voltage between 1 kV and 7 kV. This source of ions makes it possible to obtain at the exit a scattering ion beam of approximately 100 nm in diameter. The ion current density j is less than 0.8 mA/cm². The sputtered carbon is deposited on the substrate which, during deposition (at a selected periodicity), is irradiated periodically with, for example, argon ions. The deposition temperature is between approximately 180° C. and 200° C. The duration of the treatment is adjusted in such a way as to form coating 22, which has a thickness (designated d_{ADC}) between approximately 72 nm and 104 nm and a refractive index (n_{ADC}) between approximately 1.6 and 1.8.

Another technique which can be used to form the coating of amorphous diamond-like carbon consists of using toluene vapor. In this case, amorphous diamond-like carbon films are obtained by plasma chemical vapor deposition. To this end, the following parameters are proposed:
substrate temperature of approximately 600° C. to 800° C.,
chamber pressure of approximately 10⁻¹ Torr to 10⁻² Torr,
relative toluene content of the mixture of approximately 0.5% to 2.5%,
temperature of the tungsten filament of approximately 2000° C. to 2100° C.,
ion beam working current of approximately 20 mA to 50 mA under an accelerating voltage of approximately 1.5 kV to 4 kV.

A 0.8 mm diameter tungsten filament is used for plasma neutralization and toluene and hydrogen dissociation. Before the gas mixture enters the chamber, it is pumped to a vacuum pressure of approximately 10⁻⁵ Torr. The distance between the filament and the substrate is approximately 5 cm.

The ions which are thus formed are then accelerated and deposited on coating 21, so as to form coating 22.

In all cases, the technique used to deposit the coating of amorphous diamond-like carbon must be capable of forming a coating which is essentially non-porous, advantageously in which the porosity is less than 50% of the total volume of the aforesaid coating and essentially free of foreign species such as hydrogen or nitrogen. The absence of porosity or the low degree of porosity of coating 22 guarantees that porous silicon coating 21 is effectively protected against degradation (in particular chemical degradation by oxidation over time, visible after one week in the absence of protection), and the absence of significant quantities of foreign species guarantees that satisfactory and stable physical and chemical properties, which affect the optical properties of the coating, can be obtained.

It should be noted here that the spectral range in which a solar cell equipped with the coating according to the present invention effectively converts light depends on the respective thickness and refractive index values of coatings 21 and 22.

At present, no precise mathematical relationship has been demonstrated between optimal parameter values, however experimental work can be carried out to obtain the light conversion curves desired.

### EXAMPLE 1

A solar cell is equipped with a system of two coatings according to the present invention, the porous silicon (PS) coating being formed by anodization whereas the amorphous diamond-like carbon (ADC) coating is formed by ion sputtering.

The coatings have the following parameters:
d_{PS}=42 nm
n_{PS}=2.9
d_{ADC}=88 nm
n_{ADC}=1.6

The reflection factor curve, which determines the proportion of light reflected as a function of wavelength by a solar cell equipped with such a coating, is presented in FIG. 2.

FIG. 2 shows that the conversion of the cell is correct in a significant part of the visible range, whereas efficiency decreases (that is, reflection increases) towards the ultraviolet and infrared ranges.

### EXAMPLE 2

A coating with two layers is produced using the same techniques as in example 1, but with the following parameters:
d_{PS}=47.9 nm
n_{PS}=2.8
d_{ADC}=86.9 nm
n_{ADC}=1.6

The corresponding reflection factor curve is presented in FIG. 3. FIG. 3 shows conversion by the cell that is appreciably improved towards the ultraviolet range, up to a wavelength of approximately 400 nm. Conversion is also improved, but more moderately, towards the infrared range.

From an overall point of view, a solar cell equipped with the coating produced with the parameters of example 2 demonstrates a total conversion of sunlight of 70%, which is an increase of 14% compared to solar cells equipped with a traditional coating.

It should be noted here that the reflection factor curves of FIGS. 2 and 3 were obtained by simulation according to a so-called optical matrix approach such as that described, for example, in V. M. Aroutiounian, K. R. Maroutyan, A. L. Zatikyan, C. Lévy-Clément, K. J. Touryan, Proc. SPIE on Solar and Switching Materials, v. 4458, 61 (2001). The true curves determined by experimentation may be slightly different than the simulated curves of FIGS. 2 and 3.

The present invention is not limited to the description above and to the appended drawings, and many variations and modifications could be applied herein.

In particular, the coating according to the present invention advantageously can be used whenever it is desirable to limit the reflection of incidental light, such as visible, infrared or ultraviolet light, on a surface.

1. An anti-reflective coating (20), in particular for solar cells, wherein it comprises, in combination, an internal coating of anti-reflective porous silicon (21) and an external coating of amorphous diamond-like carbon (22) which is essentially non-porous and essentially devoid of foreign species.

2. A coating according to claim 1, wherein the volume of the porosity of the coating of amorphous diamond-like carbon is less than 50% of the total volume of the aforesaid coating.

3. A coating according to claims 1 or 2, wherein:
the coating of porous silicon has a thickness between approximately 38 nm and 56 nm,
the coating of porous silicon has a refractive index between approximately 2.6 and 2.9,
the coating of amorphous diamond-like carbon has a thickness between approximately 72 nm and 104 nm, and
the coating of amorphous diamond-like carbon has a refractive index between approximately 1.6 and 1.8.

4. A coating according to claim 3, wherein the coating of porous silicon has a thickness of approximately 47.9 nm and a refractive index of approximately 2.8, whereas the coating of amorphous diamond-like carbon has a thickness of approximately 86.9 nm and a refractive index of approximately 1.6.

5. A method that makes it possible to form an anti-reflective coating on an item having an exposed surface of solid silicon, such as a solar panel, wherein it is comprised of the following steps:
application of a porosification treatment to the exposed surface of solid silicon at a predetermined thickness in such a way as to form a coating of porous silicon, and
deposition of a solid coating of amorphous diamond-like carbon, one which is essentially free of foreign species, on the aforesaid coating of porous silicon.

6. A method according to claim 5, wherein the porosification treatment is anodization.

7. A method according to claim 6, wherein the anodization etching agent is selected among a mixture of hydrofluoric acid and dimethylformamide and a mixture of hydrofluoric acid and ethanol.

8. A method according to any of the claims 5 to 7, wherein the step of deposition of the solid coating of amorphous diamond-like carbon is carried out by ion sputtering using a graphite target.

9. A method according to claim 8, wherein the graphite target is bombarded with argon ions.

10. A method according to any of the claims 5 to 7, wherein the step of deposition of the solid coating of amorphous diamond-like carbon is carried out by electron bombardment of toluene vapor.

11. The use of an anti-reflective coating according to any of the claims 1 to 4 as a coating for a solar cell.
